(19) United States
(12) Patent Application Publication
(10) Pub. No.: US 2026/0163041 A1
(43) Pub. Date: Jun. 11, 2026

(54) REDOX CYCLABLE MOLECULES FOR ENERGY STORAGE

(71) Applicant: MICROSOFT TECHNOLOGY LICENSING, LLC, Redmond, WA (US)

(72) Inventors: Bichlien Hoang NGUYEN, Seattle, WA (US); Jake Allen SMITH, Seattle, WA (US); Rhys Braginton Pettee OLSEN, Redmond, WA (US); Ernesto MARTINEZ BAEZ, Seattle, WA (US)

(21) Appl. No.: 18/973,759

(22) Filed: Dec. 9, 2024

(51) Int. Cl. H01M 8/08; H01M 8/18

(52) U.S. Cl. CPC H01M 8/08; H01M 8/188; H01M 2300/0002

(57) ABSTRACT

This disclosure provides redox cyclable molecules for energy storage. These molecules are either imidazothiazoles, pyrazoliums, 1,2-benzisothiazoles, or pyridopyrimidines. Molecules in these families are used as analytes in redox flow batteries.

### BACKGROUND

A rechargeable battery is an electrochemical device that stores and releases electrical energy through reversible chemical reactions, allowing for multiple cycles of charging and discharging. Rechargeable batteries can be useful when the supply and demand for energy come at different times. One example application of rechargeable batteries is for temporary storage of energy generated by renewable energy sources when supply exceeds demand. Rechargeable batteries can also be useful to meet periodic peak demand that exceeds the capacity of the grid or other power source. One example application for rechargeable batteries is to provide energy smoothing for data centers or other large consumers of electricity.

One type of rechargeable battery is the redox flow battery (RFB). RFBs store energy in the physical separation of two charge-carrying species, an anolyte and catholyte. These batteries are characterized by their ability to decouple energy storage capacity from power output, allowing for flexible scaling. Due to their size and weight, RFBs are best suited for use in fixed locations, such as grid energy storage or industrial applications such as storing electricity from renewable energy sources or providing energy smoothing for data centers. The power and efficiency of an RFB is determined by its electrodes, conductivities of the electrolytes and kinetics of redox reactions. In current commercial implementations of RFBs, vanadium species are commonly used as the anolyte and catholyte. However, vanadium is expensive, there is limited market availability, and there are environmental concerns about the use of vanadium. Alternative chemistries for use in RFBs could address these and other problems. This disclosure is made with respect to these and other considerations.

### SUMMARY

This disclosure identifies four new families of redox cyclable molecules that can function as charge carriers in RFBs. These redox cyclable molecules are small organic molecules. A first family of molecules is the imidazothiazoles. Imidazothiazoles have a bicyclic heterocycle structure, which consists of an imidazole ring fused to a thiazole ring. This structure includes three heteroatoms: two nitrogen atoms and one sulfur atom. A second family of molecules is the pyrazoliums. Pyrazoliums have a five-membered pyrazole ring containing two adjacent nitrogen atoms one of which is positively charged. A third family of molecules is the 1,2-benzisothiazoles. 1,2-benzisothiazoles are organic hetero bicyclic chemical compounds consisting of a benzene ring fused to an isothiazole ring that includes a nitrogen heteroatom and a sulfonamide group. A fourth family of molecules is the pyridopyrimidines. Pyridopyrimidines are also organic hetero bicyclic chemical compounds consisting of pyridine ring fused orthogonally at any position to a pyrimidine ring.

All of these families of molecules are surprisingly suitable for use as anolytes in an RFB. The RFB may use organic or aqueous solutions. If aqueous, the four families of molecules have redox potentials within the useful range for aqueous RFB applications which is about −1.5 V to about +1.5 V versus a standard hydrogen electrode (SHE).

Multiple variations around the core structures are contemplated for all four families of molecules. Some of the variations target improved aqueous solubility. Other variations modulate the redox potential. Yet other variations improved stable redox behavior by blocking off decomposition pathways.

RFBs containing any of these four families of small organic molecules may be used in any application for which conventional RFBs are currently used. This includes storage of electricity generated by renewable energy sources and energy smoothing for data centers.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter. The term “techniques,” for instance, may refer to system(s) and/or method(s) as permitted by the context described above and throughout the document.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows a generalized structure of an RFB.

FIG. 2 shows structures of imidazothiazoles, specifically imidazo[2,1-b][1,3]thiazol-7-ium.

FIG. 3 shows structures of pyrazoliums.

FIG. 4 shows structures of 1,2-benzisothiazoles.

FIG. 5 shows structures of pyridopyrimidines, specifically pyrido[1,2-a]pyrimidin-5-ium.

### DETAILED DESCRIPTION

RFB technology is a promising rechargeable battery design for flexible, long-term, and safe energy storage. Unlike static batteries, RFBs allow spatial separation of the reaction area (i.e., cell stack) and storage area (i.e., catholyte/anolyte tanks), this results in the power and capacity being independent of each other. The power is determined by the area of electrode in cell stack while the capacity is determined by the concentration of electrolytes and the volume of storage tanks.

A RFB generally includes two tanks, one containing the catholyte and one containing the anolyte, a reaction chamber with two electrodes where redox reactions of the redox species take place, an ion selective membrane, and pumps for moving the anolyte solution and catholyte solution. In principle, the concentration and redox potentials of catholyte and anolyte directly determine the capacity and voltage of the RFB, respectively. The stabilities of the catholyte, anolyte, electrodes, and membrane and the rates of electrolyte crossover determine the cycle life of the RFB. In addition, the power and coulombic efficiency of the RFB is determined by its electrodes, the conductivities of its electrolytes, and kinetics of their redox reactions. The membrane separates the redox species and facilitates the conduction of charge carriers, while allowing the flow of electrons through the external circuit. The membrane diminishes crossover between catholyte and anolyte and selectively allows the transport of charge-carrier ions.

RFBs that use vanadium species for both the catholyte and anolyte are the most common commercial implementation. However, there is on-going research to identify alternative charge carrying species. Alternative metal species such as iron have been used in RFBs. See Yu, Sicen, et al. “A Low-Cost Sulfate-Based All Iron Redox Flow Battery.” Journal of Power Sources, vol. 513, 2021, p. 230457. Metal-free designs that use polymers such as lignin have also been created. See Mukhopadhyay, Alolika et al. “Metal-Free Aqueous Flow Battery with Novel Ultrafiltered Lignin as Electrolyte.” ACS Sustainable Chemistry & Engineering, vol. 6(4), 2018, 5394-5400. Colloids have also been used as catholytes in RFBs. See Wei, Z., Huang, Z., Liang, G. et al. “Starch-mediated colloidal chemistry for highly reversible zinc-based polyiodide redox flow batteries.” Nat Commun vol. 15, 2024, p. 3841. Small organic molecules have also been used to create organic redox flow batteries (ORFBs). See Li, Zening, et al. “Recent Progress in Organic Species for Redox Flow Batteries.” Energy Storage Materials, vol. 50, 2022, pp. 105-138.

The redox cyclable molecules identified in this disclosure are less expensive to obtain than vanadium and have fewer environmental issues. Additionally, organic molecules of the 1,2-benzisothiazole and pyridopyrimidine families have the potential for higher energy density than vanadium species because they can store multiple electrons per molecule in organic solvent. This represents a significant improvement over the single electron transfer in vanadium systems. Furthermore, these molecules can be engineered to have tailored specific properties enhancing the overall RFB performance. The inventors of this application have identified other suitable redox cyclable molecules in U.S. patent application Ser. No. 18/822,160 with a filing date of Aug. 31, 2024 and the title Redox Cycleable Molecules for Energy Storage.

One property that can be customized is water solubility. Side groups on any of these families of molecules may be modified to increase water solubility by adding polar groups, introducing ionic groups, and shortening the length of alkyl chains. Conversely, water solubility may be decreased by incorporating nonpolar groups such as alkyl sidechains and increasing the length of alkyl sidechains. Persons of ordinary skill in the art will understand the types of modifications to a small organic molecule that can have an effect on water solubility.

Additionally, the redox potential of any of these four family's molecules may be adjusted by modifying the side groups. Adding electron-withdrawing groups such as sulfonate or cyano can increase the redox potential by stabilizing the oxidized form, while electron-donating groups such as alkyl or amino groups decrease the redox potential by stabilizing the reduced form. Modifying sidechains to include conjugated systems or aromatic rings can alter the redox potential through electron delocalization. Bulky sidechains can influence the molecule's geometry and the accessibility of the redox-active site, affecting the redox potential. Additionally, changing the hydrophilicity or hydrophobicity of the sidechains can impact solubility and interaction with the electrolyte, indirectly influencing the redox potential. Persons of ordinary skill in the art will understand the types of modifications to a small organic molecule that can have an effect on the redox potential.

Modification side groups can also be used to prevent decomposition of the molecules by blocking common decomposition pathways. In RFBs, the stability of the redox cyclable molecules is important for efficient and long-term energy storage. Decomposition pathways are chemical reactions and processes that lead to the breakdown of these molecules over time. Identifying and mitigating common decomposition pathways, such as hydrolysis, over-oxidation, or dimerization, can create molecules that are more stable and less prone to degradation. For instance, certain functional groups may be more prone to degradation and can be modified or protected to enhance stability. Persons of ordinary skill in the art will understand how to address potential decomposition pathways by modifying side groups so that the redox cyclable molecules maintain their integrity and performance over many charge-discharge cycles, making them more suitable for use in RFBs.

Each of the four families of molecules is also suitable for use as charge carriers in RFBs because they have derivatizable synthesis routes, which make it possible to modify the side groups. A derivatizable synthesis route for an organic molecule refers to a synthetic pathway that allows for the introduction of functional groups or structural modifications at specific stages. This approach facilitates the creation of derivatives of the target molecule by incorporating points in the synthesis where modifications can be easily made.

Derivatizable synthesis routes may be identified through retrosynthesis analysis. Retrosynthesis, or retrosynthetic analysis, is a strategy used in organic chemistry to plan the synthesis of complex molecules. It involves working backward from a target molecule to simpler precursor structures. This method identifies the sequence of reactions needed to construct the target molecule from readily available starting materials. Retrosynthesis allows chemists to pinpoint key functional groups within a molecule that can be targeted for modification. By understanding the role and reactivity of these groups, specific reactions can be used to alter them. By working backward from the target molecule, it is possible to identify multiple synthetic routes. This exploration can reveal different ways to introduce or modify functional groups, providing flexibility in the synthesis process. Retrosynthetic analysis helps in evaluating the feasibility of proposed modifications. By breaking down the molecule into simpler components, persons of ordinary skill in the art can determine if the desired modifications are practical and what reagents or conditions are needed.

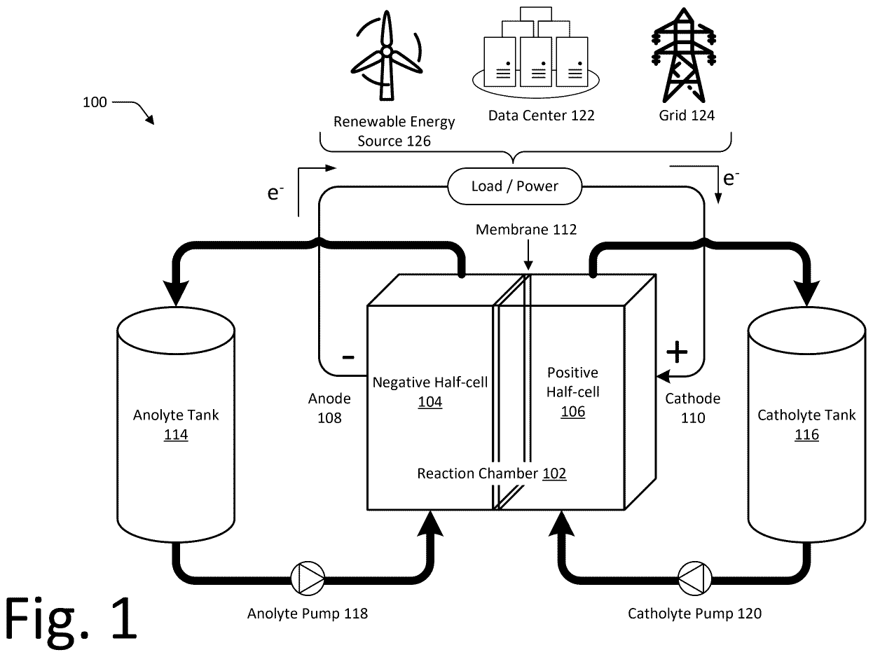

FIG. 1 shows a generalized structure of a RFB 100. The RFB 100 includes a reaction chamber 102 divided into a negative half-cell 104 and a positive half-cell 106. The negative half-cell 104 contains an anolyte solution and is in contact with an anode 108. The positive half-cell 106 contains catholyte solution and is in contact with the cathode 110. Typically, there is a membrane 112 separating the negative half-cell 104 and the positive half-cell 106. The membrane 112 maintains separation between the anolyte solution and the catholyte solution while allowing for transport of ions across the membrane 112. A catholyte is the electrolyte in a RFB that undergoes reduction at the cathode during the battery's operation. An anolyte is the electrolyte that undergoes oxidation at the anode during the battery's operation. The transport of ions across the membrane 112 completes the electrical circuit needed to generate or store electricity.

The membrane 112 may be implemented as any one of a number of different types of membranes including, but not limited to, a proton exchange membrane, a cation exchange membrane, an anion exchange membrane, a porous membrane, or a bipolar membrane. A proton exchange membrane conducts protons between the positive and negative electrolytes. A cation exchange membrane allows cations to pass and blocks anions to maintain charge balance. One example of a cationic exchange membrane is Nafion®, a fluorinated sulfonic acid polymer of perfluorosulfonic acid that exhibits high cation conductivity, good chemical stability, low water permeability, and high selectivity. Another example of a cationic exchange membrane is Flemion®, a perfluorinated carboxylic acid polymer of perfluorocarboxylic acid that offers high cation conductivity, improved chemical stability, low water permeability, and high mechanical strength. An anion exchange membrane permits anions to move between electrolytes, facilitating ion exchange. A porous membrane contains pores for selective ion transport based on size, aiding in electrolyte separation. A bipolar membrane combines cation and anion exchange layers to enhance ion separation and battery efficiency.

In some implementations, the RFB 100 may be implemented without a membrane 112. A membrane-free RFB eliminates the need for a membrane to separate the electrolytes. Instead, it relies on careful design and control of fluid dynamics to keep the positive and negative electrolytes from mixing.

An anolyte tank 114 stores the anolyte solution and contributes to the capacity of the RFB 100. Similarly, a catholyte tank 116 stores the catholyte solution. Anolyte solution from the anolyte tank 114 is moved into the negative half-cell 104 by an anolyte pump 118. The catholyte solution is moved from the catholyte tank 116 to the positive half-cell 106 by a catholyte pump 120. There are return flow paths for both the anolyte solution and the catholyte solution. The anolyte solution and the catholyte solution may be aqueous solutions or non-aqueous solutions that use an organic solvent.

The anolyte solution comprises either the four families of molecules (imidazothiazoles, pyrazoliums, 1,2-benzisothiazoles, or pyridopyrimidines). Examples and characteristics of these families of molecules are provided below. The anolyte solution may also include one or more counterions. The counterions are oppositely charged and stoichiometric to the anolyte species. The counterion, may be, but is not limited to, any of chloride (Cl⁻), bromide (Br⁻), iodide (I⁻), sulfate (SO₄²⁻), phosphate (PO₄³⁻), acetate (CH₃COO⁻), trifluoroacetate (CF₃COO⁻), tetrafluoroborate (BF₄⁻), or hexafluorophosphate (PF₆⁻). In one particular implementation, the counterion is tetrafluoroborate. Counter ions will not be present if the anolyte is a neutral species such as 1,2-benzisothiazole.

The catholyte present in the catholyte solution may be any one of a number of different types of molecules or ions including, but not limited to, chloride, bromide, iodide, potassium ferrocyanide, ferrocene, 2,2,6,6-tetramethyl-1-piperidinyloxy (TEMPO), a benzoquinone, an anthraquinone, cerous methanesulfonate, or manganese dioxide. Iodide undergoes redox reactions, converting between iodide (I⁻) and iodine (I₂) as a catholyte. Potassium ferrocyanide participates in redox reactions by alternating between its oxidized form (ferricyanide, [Fe(CN)₆]³⁻) and its reduced form (ferrocyanide, [Fe(CN)₆]⁴⁻). In its oxidized form, ferrocene (Fc) is converted to ferrocenium (Fc⁺), and this redox couple facilitates electron transfer during an RBS's charge and discharge cycles. Ferrocene derivatives are particularly attractive for aqueous ORFBs due to their high solubility, stability, and tunable redox potentials. TEMPO is a stable free radical that can be oxidized to its cationic form (TEMPO⁺) and reduced back to its neutral form. This redox couple facilitates electron transfer during the charge and discharge cycles of the battery and is characterized by high solubility, stability, and well-defined redox potential. Benzoquinones, such as 1,4-benzoquinone, have high redox potential and good solubility in aqueous solutions. They alternate between their oxidized form (benzoquinone) and reduced form (hydroquinone), as a catholyte. Anthraquinones, such as anthraquinone-2,7-disulfonic acid (AQDS), have high chemical stability and tunable redox properties. They undergo redox reactions between their oxidized form (anthraquinone) and reduced form (anthrahydroquinone). Cerous methanesulfonate can function as a catholyte in redox flow batteries (RFBs) by participating in redox reactions where cerium ions alternate between different oxidation states. Specifically, cerium(III) ions (Ce³⁺) are oxidized to cerium(IV) ions (Ce⁴⁺) during the charging process and reduced back to Ce³⁺ during discharge. This redox couple is advantageous due to its high solubility in aqueous solutions and its stable redox potential, which contributes to efficient energy storage and release.

One or both of the anolyte solution and the catholyte solution may also contain a supporting electrolyte. Generally, but not always, the identity and concentration of the supporting electrolyte is identical in both the anolyte solution and the catholyte solution. Supporting electrolytes play an important role in RFBs by facilitating the flow of electrical charge between the positive and negative electrodes, enabling the efficient storage and release of energy. These electrolytes act as a conductive medium, allowing ions to move freely and complete the circuit, while also maintaining the chemical stability and overall performance of the battery. The choice of supporting electrolyte may depend on the type of solution used for the RFB 100, either aqueous or organic non-aqueous. Example supporting electrolytes that may be used with aqueous solutions include, but are not limited to, sodium hydroxide (NaOH), perchloric acid (HClO₄), potassium chloride (KCl), and sulfuric acid (H₂SO₄). Example supporting electrolytes that may be used with non-aqueous solutions include, but are not limited to, tetrabutylammonium tetrafluoroborate (TBATFB), tetraethylammonium phosphate (TEAP), lithium hexafluorophosphate (LiPF₆), and trifluoroacetic acid (TFA). The molecules used as the anolyte are selected (e.g., core structure and side groups) to have a redox potential within the electrochemical window of a solution of the supporting electrolyte.

The RFB 100 is capable of both generating current in response to a load or storing energy when charged by a power source. FIG. 1 illustrates electrons flowing from the anode 108 to the cathode 110 representing discharge of the battery. However, when charged by a power source, electrons will flow in the opposite direction from the cathode 110 to the anode 108 (not shown). In one implementation, the RFB 100 may be used to supply power to a data center 122. The data center 122, is but one example of a load that may be placed on the RFB 100. The RFB 100 may be used to supply power to any number of other types of facilities and machines.

When used as a power source for a data center 122, the RFB 100 may provide energy smoothing for the data center 122. Energy smoothing is a technique employed in data centers to mitigate fluctuations in electricity demand, ensuring a stable and consistent power supply. By reducing peak demand, improving power quality, and increasing efficiency, energy smoothing optimizes energy usage and minimizes strain on the electrical infrastructure. This is important in data centers, where electricity demand can vary significantly throughout the day.

To achieve energy smoothing, the data center 122 uses the RFB 100 to store and release electrical energy as needed, buffering against demand fluctuations and ensuring a reliable power supply. The RFB 100 receives energy from an external source such as the grid 124 or a renewable energy source 126. The grid 124 is a system comprising interconnected electrical networks designed for the generation, transmission, and distribution of electrical power to end users. By implementing energy smoothing techniques, data centers can reduce environmental impact, lower energy costs, and maintain optimal operating conditions. By storing excess energy during periods of low demand, the RFB 100 can effectively buffer against fluctuations in power usage. This is achieved through the reversible redox reactions of the anolyte and the catholyte, converting electrical energy into chemical energy. During periods of low demand, the RFB 100 stores excess energy converting electrical energy into chemical energy. When demand spikes, the process reverses, releasing stored energy to the data center 122 reducing peak demand placed on the grid 124 or other power source.

In an implementation, the RFB 100 can be used to store and release energy generated from renewable energy sources 126 such as solar panels or wind turbines. These types of renewable energy sources 126 are intermittent sources of power that have variations in power generation capacity. The RFB 100 can store large amounts of energy generated from renewable energy sources 126 during peak production times (e.g., sunny or windy periods) and release it when production is low (e.g., cloudy or calm periods). By buffering the energy output from renewable energy sources 126, the RFB 100 can help balance the grid by enabling a consistent power supply despite the variability of renewable energy generation.

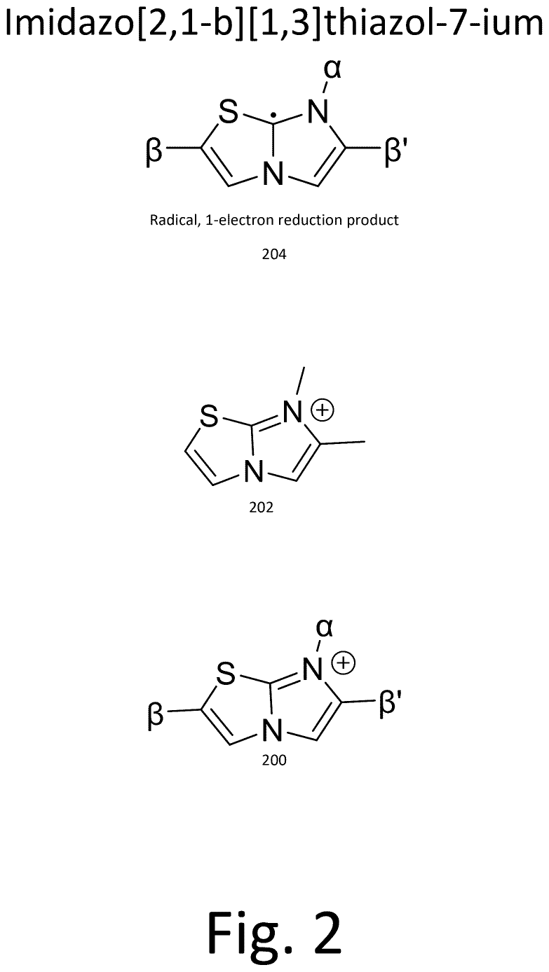

FIG. 2 shows structures of the imidazothiazole family of molecules. Imidazothiazoles exhibit redox properties due to their bicyclic heterocyclic structure, comprising an imidazole ring fused to a thiazole ring with three heteroatoms: two nitrogen and one sulfur atom. This arrangement facilitates electron transfer reactions. The sulfur atom, which is readily oxidizable, enables imidazothiazoles to undergo reversible oxidation-reduction reactions. Additionally, the aromatic character of both rings contributes to their electron-rich environment, enhancing the reducing capabilities. The presence of nitrogen atoms further influences redox behavior by participating in electron transfer and stabilization.

One specific imidazothiazole structure is imidazo[2,1-b][1,3]thiazol-7-ium. Imidazo[2,1-b][1,3]thiazol-7-ium is a bicyclic heterocyclic compound consisting of fused imidazole and thiazole rings, with a positive charge delocalized across the ring system. The electronic structure features resonance-stabilized aromaticity and the positive charge makes it an electrophilic species capable of participating in various chemical reactions. A generalized structure with non-specified side groups for imidazo[2,1-b][1,3]thiazol-7-ium is structure 200 in FIG. 2 and is shown below:

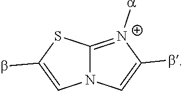

This imidazo[2,1-b][1,3]thiazol-7-ium structure 200 is a cationic species with a positive charge localized at the 7-position. The α group may be any of methyl, ethyl, propyl, butyl, or CH₂Ph. The β and β′ groups may be the same or different and are each independently one of H, OH, CN, F, NH₃+, CO₂H, CO₂Me, CONH₂, methyl, ethyl, propyl, butyl, phenyl,

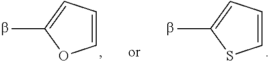

Although β is shown in the representation of the side groups, it is to be understood that it may also represent β′. Also, β, when shown as part of a side group, represents the point of attachment to the imidazole ring or the thiazole ring.

In one implementation, the α group is methyl. One implementation, the β group is H. In one implementation, the β′ group is methyl. One example imidazothiazole structure is compound 202 in which the α group and β prime group are both methyl and the β group is H.

Under some conditions the imidazothiazole may be present as a stable reduced species such as a radical, 1-electron reduction product 204:

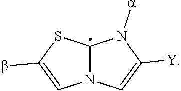

A radical, 1-electron reduction product of an imidazothiazole is formed when one electron is added to the cationic species creating a neutral imidazothiazole. This reduction results in the formation of a radical anion. The added electron is shown localized on the carbon atom shared by the two rings. However, the unpaired electron creates a shift in electron density that may result in redistribution of electrons across other atoms in the molecule such as the sulfur atom of the thiazole ring. The unpaired electron in 1-electron reduction product 204 is stabilized by aromatic resonance structures and may be further stabilized by the captodative effect with introduction of side groups.

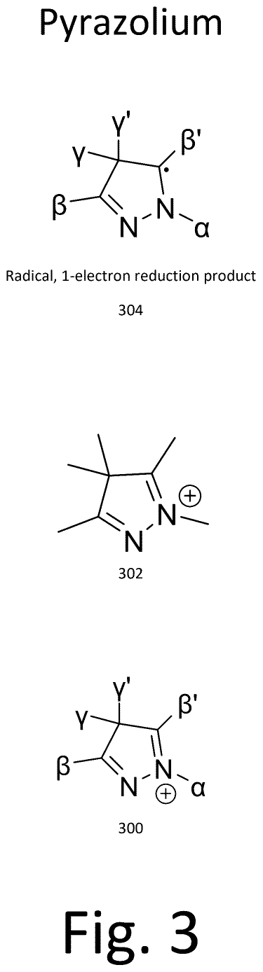

FIG. 3 shows structures of the pyrazolium family of molecules. The core structure is a pyrazole derivative comprising a five-membered aromatic ring containing two adjacent nitrogen atoms, with one nitrogen bearing a positive charge, resulting in a delocalized π-electron system. The positively charged nitrogen atom makes the molecule susceptible to reduction, and the compound can act as an electron acceptor in redox reactions. Upon reduction, the molecule gains an electron, neutralizing the positive charge and forming the neutral pyrazole radical. The presence of the positive charge allows for both one-electron and two-electron reduction pathways, and the compound can participate in various electron transfer processes depending on the reaction conditions and the reducing agent employed. In the presence of certain side groups, the radical species may be stabilized by aromaticity and/or the captodative effect. The reduction potential is influenced by substituents on the ring, with electron-withdrawing groups generally making reduction more favorable.

The pyrazolium core structure 300 is shown below:

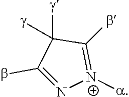

The α group may be any of methyl, ethyl, propyl, butyl, or CH₂Ph. The β and β′ groups may be the same or different and are each independently one of H, CO₂H, CO₂Me, CONH₂, methyl, ethyl, propyl, butyl, phenyl,

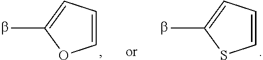

Although β is shown in the representation of the side groups, it is to be understood that it may also represent β′. The γ and γ′ groups may be the same or different and are each independently one of H, CO₂H, CO₂Me, CONH₂, methyl, ethyl, propyl, butyl, phenyl,

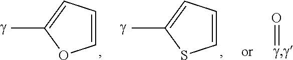

(representing a carbonyl group (C═O) at the ring carbon to which γ and γ′ are attached). Although only γ is shown in the representation of some side groups, is to be understood that it may also represent γ′. When shown as part of a side group, β, γ, and γ′ represents the point of attachment to the pyrazole ring.

In one implementation, one or more of the α group, β group, β′ group, γ group, and γ′ group are methyl. One example structure in which all of those groups are methyl is compound 302 shown in FIG. 3.

Under some conditions the pyrazoliums may be present as a stable reduced species such as a radical, 1-electron reduction product 304:

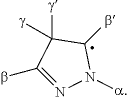

The radical, 1-electron reduction product 304 of pyrazoliums is formed when one electron is added to the cationic species, creating a neutral radical species. The added electron is shown localized on the carbon atom to which the β′ group is attached, as indicated by the dot (⋅) in the structure. However, the unpaired electron results in delocalization of electron density throughout the conjugated system of the molecule, particularly involving the adjacent nitrogen atoms. The molecule is no longer cationic, as the addition of one electron neutralizes the positive charge. Because of the unpaired electron, this neutral radical species is reactive and can participate in various radical-mediated reactions. The stability and reactivity of this radical species is influenced by the substituents (α, β, β′, γ, and γ′) attached to the ring system.

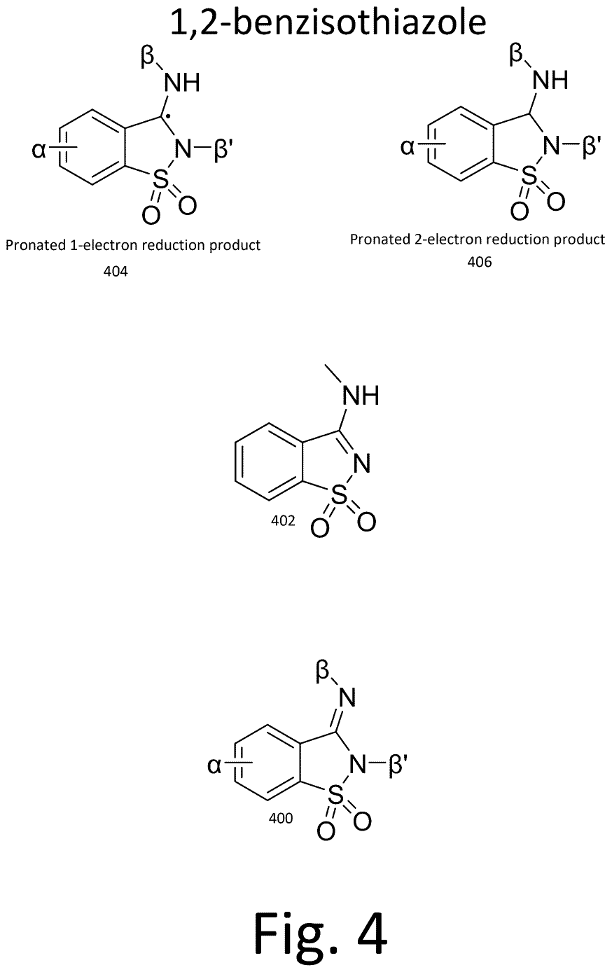

FIG. 4 shows the structure of the 1,2-benzisothiazole family of molecules. 1,2-benzisothiazoles are composed of a benzothiazole sulfone, a fused ring system that includes a benzene ring and a thiazole ring where the sulfur atom in the sulfone oxidation state. The sulfone group is a strong electron-withdrawing group, which decreases the electron density in the ring system and makes it prone to reduction.

In addition to electrochemical reductions, 1,2-benzisothiazoles can undergo oxidation reactions, such as electrochemical oxidation, to form radical cations or other oxidized species. These reactions are typically reversible, allowing the 1,2-benzisothiazole molecule to be reduced back to its original form. The conjugation within the benzothiazole ring system delocalizes electrons, stabilizing the molecule and increasing its redox potential. This delocalization reduces the molecule's tendency to donate or accept electrons. The fused ring system maintains aromaticity, which enhances the stability of the molecule. Aromatic compounds tend to resist changes in their electronic configuration, which influences their redox reactions. Conjugation allows for resonance structures, distributing electron density across the molecule and affecting electron transfer reactions.

The 1,2-benzisothiazoles core structure 400 is shown below:

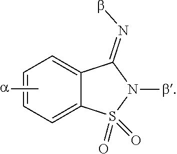

The α group may be any of H, OH, NH₂, Cl, F, SO₃H, PO₃H₂, CO₂H, CO₂Me, CONH₂, methyl, ethyl, propyl, butyl, phenyl,

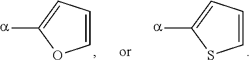

When α is shown in one of the side groups it represents a point of connection to the benzene ring. The β group may be any one of H, methyl, ethyl, propyl, butyl, phenyl, or CH₂Ph. The β′ group is optional and may be absent, and if absent the nitrogen forms a double bond to the adjacent carbon. If present, the β′ group may be any one of H, methyl, ethyl, propyl, butyl, phenyl, or CH₂Ph.

In one implementation, the α group is H. In one implementation, β is methyl. In one implementation, β′ is absent. One example 1,2-benzisothiazole structure is compound 402 shown in FIG. 4 in which the α group is H, β is methyl, and β′ is absent.

Under some conditions, the 1,2-benzisothiazoles may be present as a stable reduced species such as a protonated, 1-electron reduction product 404:

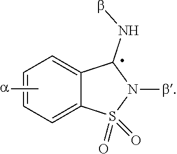

The gain of one electron and acceptance of a proton from the solvent or buffer system produces a neutral radical species. The unpaired electron is not localized but instead delocalized throughout the conjugated π-system of both the benzene and thiazole rings, with significant radical character at the carbon atom bearing the β′ group, as shown by the dot (⋅) in the structure, due to stabilization by the captodative effect. This reduction involves both electron transfer and proton acceptance, likely at the external nitrogen. The electron-withdrawing sulfonyl group and extended conjugation stabilize the radical and influence its redox potential. The system typically shows quasi-reversible electrochemistry, with reduction potentials influenced by the substituents (α, β, and β′) attached to the ring system.

Under some conditions, the pyrazoliums may be present as a protonated, 2-electron reduction product 406:

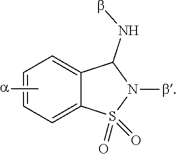

The 2-electron reduction and protonation of 1,2-benzisothiazole produces a neutral species through the gain of two electrons and two protons. This creates a fully reduced, neutral molecule without unpaired electrons. The electron density is distributed through the conjugated system, with significant localization at the nitrogen bearing the β′ group. This reduction involves sequential electron transfers and proton acceptances, with protonation likely occurring at both the external nitrogen and the adjacent ring carbon. The electron-withdrawing sulfonyl group and extended conjugation influence the stepwise reduction potentials and reduces the rate of elimination of the external nitrogen.

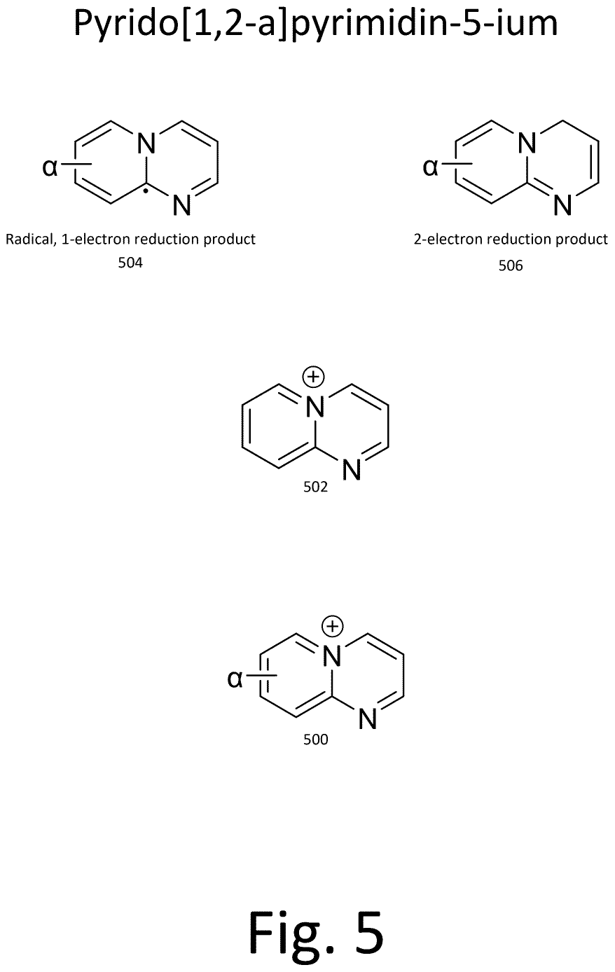

FIG. 5 shows the structure of the pyridopyrimidine family of molecules. The structure of pyridopyrimidine consists of a fused ring system featuring a pyridine ring and a pyrimidine ring connected orthogonally at any position. The presence of nitrogen atoms in both rings facilitates electron donation and acceptance, and the planar, conjugated rings enhance electron delocalization. The electron-poor nature of pyridopyrimidine, facilitated by nitrogen atoms in both rings, enables it to participate in electron transfer reactions, and the redox potential is influenced by the specific arrangement of these atoms and the presence of side groups.

One specific pyridopyrimidine structure is pyrido[1,2-a]pyrimidin-5-ium. The pyrido[1,2-a]pyrimidin-5-ium is a fused bicyclic aromatic system consisting of a pyridine ring fused to a pyrimidine ring, sharing a common N—C bond. It forms a 10 π-electron cationic heterocyclic system where the nitrogen at position 5 carries a formal positive charge. The bridging nitrogen is part of both rings, creating a planar structure that enables electron delocalization throughout the molecule. This positively charged heterocycle has bond angles and lengths influenced by the strain of the fused ring system and the electronic effects of the charged nitrogen. The pyrido[1,2-a]pyrimidin-5-ium core structure 500 is shown below:

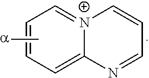

The α group may be any of H, OH, NH₂, Cl, F, SO₃H, PO₃H₂, CO₂H, CO₂Me, CONH₂, methyl, ethyl, propyl, butyl, phenyl,

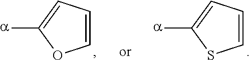

For the side groups that include α, it represents the point of connection to the pyridine ring.

In one implementation, the α group is hydrogen. One example pyrido[1,2-a]pyrimidin-5-ium structure in which α is hydrogen is shown as compound 502 in FIG. 5.

Under some conditions the pyridopyrimidines may be present as a stable reduced species such as a radical, 1-electron reduction product 504:

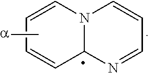

A radical, 1-electron reduction product of pyrido[1,2-a]pyrimidin-5-ium is formed when one electron is added to the cationic species. This reduction results in the formation of a neutral radical species. The added electron is shown localized on the carbon atom connecting the two rings, as indicated by the dot (⋅) in the structure. However, the added electron is delocalized across the molecule, contributing to the stability of the radical. While this radical is relatively stable due to the delocalization of the unpaired electron, it can still participate in various chemical reactions. The stability and redox potential of radical, 1-electron reduction product is influenced by the α group.

Under some conditions, the pyrazoliums may be present as a protonated, 2-electron reduction product 506:

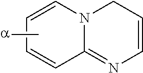

The 2-electron reduction and protonation of pyrido[1,2-a]pyrimidin-5-ium produces a neutral species through the gain of two electrons and two protons. This creates a fully reduced, neutral molecule without unpaired electrons. The electron density is distributed through the conjugated system, with significant localization at the 5-position nitrogen. This reduction involves sequential electron transfers and proton acceptances, with protonation likely occurring at both the 2-position carbon.

### Predicted Electrode Potentials

Experimentally determined and predicted standard electrode potentials (E°) for molecules having the same core structures as shown in FIGS. 2-5 are provided in Table 1 below. Predicted E° were calculated using Density Functional Theory (DFT) and the Nernst equation. A rapid single-electron transfer relative to all proceeding mechanistic steps was assumed. Initial structures were relaxed with GFN2−xTB (GFN2−xTB is a semi-empirical quantum mechanical method for fast and accurate calculations of molecular structures, energies, and properties that uses the Generalized Functional for Nanostructures and second-generation tight-binding method with extended basis set. It is a simplified version of DFT, making it computationally efficient for large systems), then Self-Consistent Field (SCF) energies of the initial and +/− electron structures computed with the PW6B95 functional (Perdew-Wang exchange-correlation functional which includes a mix of 6% Hartree-Fock exchange and 95% Becke exchange) and def2tzvp basis set (including triple-zeta (TZ) quality for valence orbitals and additional polarization functions (p) for accurate description of molecular properties) with D3(BJ) dispersion (a dispersion correction method that includes a damping function that improves the accuracy of dispersion energies) and ddCOSMO (explicitly specifying the solvent as water) implicit solvent corrections.

For all four families of redox cyclical molecules, the predicted E° is similar to the experimentally determined E° for other molecules with similar core structures. The differences are likely attributable to the differences in structure and organic solvent for some of the values from the literature. The similarity indicates that the predicted values for E° are likely accurate predictions of the experimental behavior of these molecules. Moreover, cyclic voltammograms from the literature referenced in Table 1 show that each of the families of molecules can undergo repeated reduction and oxidation reactions.

The predicted E° range between −1.5 V to 0 V. All values are provided as the standard electrode potential of a redox reaction, measured in volts relative to a Saturated Calomel Electrode (SCE). These differences are interpreted in the context of the useful range of redox potentials for aqueous RFB applications which is about −1.5 V to about +1.5 V verses standard hydrogen electrode (SHE) which is 0.242 V less than SCE. This range can be expanded if an organic solvent is used. Moreover, both the predicted and experimental values are well within the desired range of −1.5 V to +1.5 V verses SHE. Accordingly, the predicted redox potentials shown in Table 1 below are believed to be reasonably accurate predictions.

TABLE 1
Predicted and experimental E°.

| | Predicted | | |
|---|---|---|---|
| | E° | | |
| | (V versus | | Experimental E° |
| Molecule | SCE) | Literature Molecule | (V versus SCE) |
| 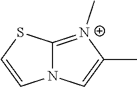 imidazo[2,1- b][1,3]thiazol-7-ium | −1.3 | 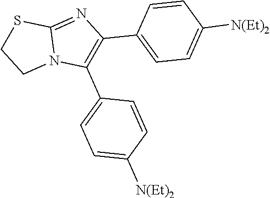 | −0.39 (0.1 M TEAClO₄ in acetonitrile) Cheng et al. 1989 |
| 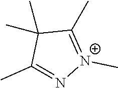 pyrazolium | −1.1 | 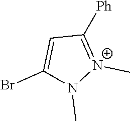 | −1.5 (0.1 M TBABF₄ in acetonitrile) Pospíšil et al. 1991 |
| 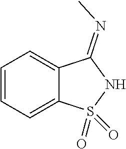 1,2-benzisothiazole | −0.43 | 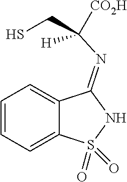 [SMILES: O=C(O)[C@H](CS)/N=C1/NS(=O)(=O)c2ccccc21] | −0.5 (Britton- Robinson buffer, pH 9.0) çakιr, et al. 2009 |
| 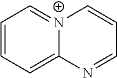 pyrido[1,2- a]pyrimidin-5-ium | −0.85 | 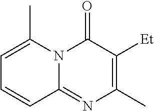 | −1.45 (aqueous, pH 9.1) Szebényi-Győry et al. 1985 |

Cheng, Hung-Yuan, et al. “Electrochemical Investigations of Anti-inflammatory Agents 5,6-Substituted-2,3-dihydroimidazo[2,1-b]thiazoles.” Journal of the Electrochemical Society 136.12 (1989): 3679.

Pospíšil, L., et al. “Electrochemical properties of difenzoquat herbicide (1,2-dimethyl-3,5-diphenyl-pyrazolium).” Journal of electroanalytical chemistry and interfacial electrochemistry 310.1-2 (1991): 169-178.

Çakir, Semiha, et al. “Synthesis, spectroscopic and voltammetric studies of a novel Schiff-base of cysteine and saccharin.” Journal of Molecular Structure 918.1-3 (2009): 81-87.

Szebényi-Györy, E., et al. “Electrochemical synthesis of pyrido[1,2-a]pyrimidine derivatives. II. Electrochemical reduction of 2,6-dimethyl-3-ethyl-4-oxo-4H-pyrido[1,2-a]pyrimidine in aqueous media.” Journal of applied electrochemistry 15.1 (1985): 145-150.

Each of the four families of redox cyclical molecules, including the options for various side groups, may be synthesized using techniques and knowledge of one of ordinary skill in the art of organic chemical synthesis. Examples of suitable techniques may be found in multiple reference materials including Carey, Francis A., and Richard J. Sundberg. Advanced Organic Chemistry: Part B: Reaction and Synthesis. 5th ed., Springer, 2007; Smith, Michael B., and Jerry March. March's Advanced Organic Chemistry: Reactions, Mechanisms, and Structure. 7th ed., Wiley, 2013; Kürti, László, and Barbara Czakó. Strategic Applications of Named Reactions in Organic Synthesis. 1st ed., Elsevier Academic Press, 2005; Larock, Richard C. Comprehensive Organic Transformations: A Guide to Functional Group Preparations. 2nd ed., Wiley-VCH, 1999; and Zweifel, George S., and Michael H. Nantz. Modern Organic Synthesis: An Introduction. 1st ed., W.H. Freeman, 2006.

### Definitions

As used herein, H represents a hydrogen atom, the simplest functional group consisting of one proton and one electron; OH represents a hydroxyl group, a functional group consisting of an oxygen atom bonded to a hydrogen atom; NH₂ represents an amino group, a functional group consisting of a nitrogen atom bonded to two hydrogen atoms; NH₃+ represents a positively charged ammonium substituent or alkylammonium group consisting of a nitrogen bonded to three hydrogen atoms; Cl represents a chloro group, a functional group consisting of a single chlorine atom; CN represents a cyano group, a functional group consisting of a carbon atom triple-bonded to a nitrogen atom; and F represents a fluoro group, consisting of a single fluorine atom; SO₃H represents a sulfonic acid group, a functional group consisting of a sulfur atom double-bonded to two oxygen atoms and single-bonded to a hydroxyl group; and PO₃H₂ represents a phosphonic acid group, a functional group consisting of a phosphorus atom double-bonded to one oxygen atom, single-bonded to two hydroxyl groups, and single-bonded to another atom or group of atoms.

As used herein, an alkyl side chain is a saturated hydrocarbon group attached to a larger molecular structure, typically consisting of a chain of carbon atoms bonded to hydrogen atoms, with the general formula CₙH₂ₙ₊₁. As used herein, a methyl group is an alkyl side chain consisting of one carbon atom bonded to three hydrogen atoms (CH₃), typically denoting a simple, single-carbon branching. As used herein, an ethyl group is an alkyl side chain composed of two carbon atoms bonded to five hydrogen atoms (C₂H₅), representing a two-carbon branching. As used herein, a propyl group is an alkyl side chain containing three carbon atoms bonded to seven hydrogen atoms (C₃H₇), signifying a three-carbon branching. As used herein, a butyl group is an alkyl side chain consisting of four carbon atoms bonded to nine hydrogen atoms (C₄H₉), indicating a four-carbon branching. As used herein, a phenyl group is an aromatic side chain derived from benzene, consisting of six carbon atoms bonded to five hydrogen atoms (C₆H₅), typically representing aromatic ring structures.

As used herein, CH₂Ph represents a benzyl group that consists of a phenyl ring (a six-membered aromatic ring) attached to a methylene (—CH₂—) bridge that provides attachment to a core structure. As used herein, CO₂H represents a carboxylic acid group that consists of a carbon atom double-bonded to an oxygen atom and single-bonded to a hydroxyl group (—OH). The carbon atom is the point of attachment to a core structure. As used herein, CO₂Me represents a methyl ester group (—CO₂CH₃) where the methylene bridge is the point of attachment to a core structure. As used herein, CONH₂ represents an amide group that consists of a carbonyl group (C═O) bonded to a nitrogen atom. The carbon atom is the point of attachment to a core structure.

As used herein,

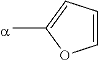

represents a furan ring consisting of a five-membered heterocyclic aromatic ring containing four carbon atoms and one oxygen atom. The α represents the point of attachment to from the ring to a core structure. As used herein,

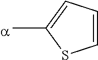

represents a thiophene ring consisting of five-membered heterocyclic ring of four carbon atoms and one sulfur atom. The α (or other Greek letter such as β or γ) represents the point of attachment to from the ring to a core structure.

### Illustrative Embodiments

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. An organic redox flow battery having an anolyte that is an imidazothiazole.

Clause 2. The organic redox flow battery of clause 1, wherein the imidazothiazole is imidazo[2,1-b][1,3]thiazol-7-ium.

Clause 3. The organic redox flow battery of clause 2, wherein the imidazo[2,1-b][1,3]thiazol-7-ium has the structure:

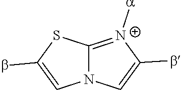

wherein, α is methyl, ethyl, propyl, butyl, or CH₂Ph, and
wherein, β and β′ are each independently H, OH, CN, F, NH₃+, CO₂H, CO₂Me, CONH₂, methyl, ethyl, propyl, butyl, phenyl,

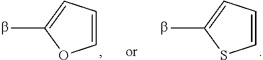

Clause 4. The organic redox flow battery of clause 3, wherein α is methyl.

Clause 5. The organic redox flow battery of clause 3 or 4, wherein β is H.

Clause 6. The organic redox flow battery of any of clauses 3-5, wherein β′ is methyl.

Clause 7. The organic redox flow battery of clause 3, wherein α is methyl, β is H, and β′ is methyl. (For example structure 202.)

Clause 8. The organic redox flow battery of any of clauses 1-7, further comprising a catholyte that is chloride, bromide, iodide, potassium ferrocyanide, ferrocene, 2,2,6,6-tetramethyl-1-piperidinyloxy (TEMPO), a benzoquinone, an anthraquinone, cerous methanesulfonate, or manganese dioxide.

Clause 9. The organic redox flow battery of any of clauses 1-8, further comprising a counterion, wherein the counterion is chloride, bromide, iodide, sulfate, phosphate, acetate, trifluoroacetate, tetrafluoroborate, or hexafluorophosphate.

Clause 10. The organic redox flow battery of any of clauses 1-9, further comprising a supporting electrolyte that is sodium hydroxide, perchloric acid, potassium chloride, sulfuric acid, tetrabutylammonium tetrafluoroborate, tetraethylammonium phosphate, lithium hexafluorophosphate, or trifluoroacetic acid.

Clause 11. The organic redox flow battery of any of clauses 1-10, wherein the anolyte has a redox potential of about −1.5 V to about +1.5 V versus a standard hydrogen electrode.

Clause 12. The organic redox flow battery of any of clauses 1-11, further comprising a membrane wherein the membrane is a proton exchange membrane, a cation exchange membrane, an anion exchange membrane, a porous membrane, or a bipolar membrane.

Clause 13. An organic redox flow battery having an anolyte that is a pyrazolium.

Clause 14. The organic redox flow battery of clause 13, wherein the pyrazolium has the structure:

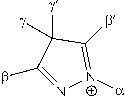

wherein α is methyl, ethyl, propyl, butyl, or CH₂Ph,
wherein β and β′ are each independently H, CO₂H, CO₂Me, CONH₂, methyl, ethyl, propyl, butyl, phenyl,

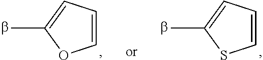

and
wherein γ and γ′ are each independently H, CO₂H, CO₂Me, CONH₂, methyl, ethyl, propyl, butyl, phenyl,

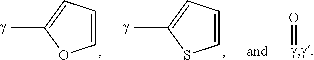

Clause 15. The organic redox flow battery of clause 14, wherein at least one α, β, β′, γ, or γ′ is methyl.

Clause 16. The organic redox flow battery of clause 14, wherein all of α, β, β′, γ, and γ′ are methyl. (For example structure 302.)

Clause 17. The organic redox flow battery of any of clauses 13-16, further comprising a catholyte that is chloride, bromide, iodide, potassium ferrocyanide, ferrocene, 2,2,6,6-tetramethyl-1-piperidinyloxy (TEMPO), a benzoquinone, an anthraquinone, cerous methanesulfonate, or manganese dioxide.

Clause 18. The organic redox flow battery of any of clauses 13-17, further comprising a counterion, wherein the counterion is chloride, bromide, iodide, sulfate, phosphate, acetate, trifluoroacetate, tetrafluoroborate, or hexafluorophosphate.

Clause 19. The organic redox flow battery of any of clauses 13-18, further comprising a supporting electrolyte that is sodium hydroxide, perchloric acid, potassium chloride, sulfuric acid, tetrabutylammonium tetrafluoroborate, tetraethylammonium phosphate, lithium hexafluorophosphate, or trifluoroacetic acid.

Clause 20. The organic redox flow battery of any of clauses 13-19, wherein the anolyte has a redox potential of about −1.5 V to about +1.5 V versus a standard hydrogen electrode.

Clause 21. The organic redox flow battery of any of clauses 13-20, further comprising a membrane wherein the membrane is a proton exchange membrane, a cation exchange membrane, an anion exchange membrane, a porous membrane, or a bipolar membrane.

Clause 22. An organic redox flow battery having an anolyte that is a 1,2-benzisothiazole.

Clause 23. The organic redox flow battery of clause 22, wherein the 1,2-benzisothiazole has the structure:

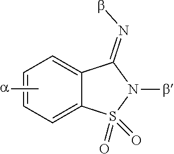

wherein α is H, OH, NH₂, Cl, F, SO₃H, PO₃H₂, CO₂H, CO₂Me, CONH₂, methyl, ethyl, propyl, butyl, phenyl,

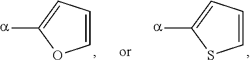

wherein β is H, methyl, ethyl, propyl, butyl, phenyl, or CH₂Ph, and
wherein β′ is absent, H, methyl, ethyl, propyl, butyl, phenyl, or β-CH₂Ph.

Clause 24. The organic redox flow battery of clause 23, wherein α is H.

Clause 25. The organic redox flow battery of clause 23 or 24, wherein β is methyl.

Clause 26. The organic redox flow battery of any of clauses 23-25, wherein β′ is absent.

Clause 27. The organic redox flow battery of clause 23, wherein α is H, β is methyl, and β′ is absent. (For example structure 402.)

Clause 28. The organic redox flow battery of any of clauses 22-27, further comprising a catholyte that is chloride, bromide, iodide, potassium ferrocyanide, ferrocene, 2,2,6,6-tetramethyl-1-piperidinyloxy TEMPO), a benzoquinone, an anthraquinone, cerous methanesulfonate, or manganese dioxide.

Clause 29. The organic redox flow battery of any of clauses 22-28, further comprising a supporting electrolyte that is sodium hydroxide, perchloric acid, potassium chloride, sulfuric acid, tetrabutylammonium tetrafluoroborate, tetraethylammonium phosphate, lithium hexafluorophosphate, or trifluoroacetic acid.

Clause 30. The organic redox flow battery of any of clauses 22-29, wherein the anolyte has a redox potential of about −1.5 V to about +1.5 V versus a standard hydrogen electrode.

Clause 31. The organic redox flow battery of any of clauses 22-30, further comprising a membrane wherein the membrane is a proton exchange membrane, a cation exchange membrane, an anion exchange membrane, a porous membrane, or a bipolar membrane.

Clause 32. An organic redox flow battery having an anolyte that is a pyridopyrimidine.

Clause 33. The organic redox flow battery of clause 32, wherein the pyridopyrimidine is pyrido[1,2-a]pyrimidin-5-ium.

Clause 34. The organic redox flow battery of clause 33, wherein the pyrido[1,2-a]pyrimidin-5-ium has the structure:

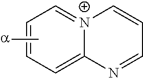

wherein α is H, OH, NH₂, Cl, F, SO₃H, PO₃H₂, CO₂H, CO₂Me, CONH₂, methyl, ethyl, propyl, butyl, phenyl,

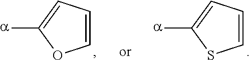

Clause 35. The organic redox flow battery of clause 34, wherein α is H. (For example structure 502.)

Clause 36. The organic redox flow battery of any of clauses 32-35, further comprising a catholyte that is chloride, bromide, iodide, potassium ferrocyanide, ferrocene, 2,2,6,6-tetramethyl-1-piperidinyloxy (TEMPO), a benzoquinone, an anthraquinone, cerous methanesulfonate, or manganese dioxide.

Clause 37. The organic redox flow battery of any of clauses 32-36, further comprising a counterion, wherein the counterion is chloride, bromide, iodide, sulfate, phosphate, acetate, trifluoroacetate, tetrafluoroborate, or hexafluorophosphate.

Clause 38. The organic redox flow battery of any of clauses 32-37, further comprising a supporting electrolyte that is sodium hydroxide, perchloric acid, potassium chloride, sulfuric acid, tetrabutylammonium tetrafluoroborate, tetraethylammonium phosphate, lithium hexafluorophosphate, or trifluoroacetic acid.

Clause 39. The organic redox flow battery of any of clauses 32-38, wherein the anolyte has a redox potential of about −1.5 V to about +1.5 V versus a standard hydrogen electrode.

Clause 40. The organic redox flow battery of any of clauses 32-39, further comprising a membrane wherein the membrane is a proton exchange membrane, a cation exchange membrane, an anion exchange membrane, a porous membrane, or a bipolar membrane.

### CONCLUSION

Although the subject matter has been described above, it is to be understood that the subject matter defined in the appended claims is not necessarily limited to the specific features or acts described above. Rather, the specific features and acts are disclosed as example forms of implementing the claims.

The terms “a,” “an,” “the” and similar referents used in the context of describing the invention are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context. The terms “portion,” “part,” or similar referents are to be construed as meaning at least a portion or part of the whole including up to the entire noun referenced. As used herein, “approximately” or “about” or similar referents denote a range of ±10% of the stated value.

Certain embodiments are described herein, including the best mode known to the inventors for carrying out the invention. Of course, variations on these described embodiments will become apparent to those of ordinary skill in the art upon reading the foregoing description. Skilled artisans will know how to employ such variations as appropriate, and the embodiments disclosed herein may be practiced otherwise than specifically described. Accordingly, all modifications and equivalents of the subject matter recited in the claims appended hereto are included within the scope of this disclosure. Moreover, any combination of the above-described elements in all possible variations thereof is encompassed by the invention unless otherwise indicated herein or otherwise clearly contradicted by context.

Furthermore, references have been made to publications, patents, and/or patent applications throughout this specification. Each of the cited references is individually incorporated herein by reference for its particular cited teachings as well as for all that it discloses. The auxiliary PDF of the specification filed together with this application is also expressly incorporated by reference.

1. An organic redox flow battery having an anolyte that is an imidazothiazole.

2. The organic redox flow battery of claim 1, wherein the imidazothiazole is imidazo[2,1-b][1,3]thiazol-7-ium.

3. The organic redox flow battery of claim 2, wherein the imidazo[2,1-b][1,3]thiazol-7-ium has the structure: 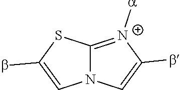
wherein, α is methyl, ethyl, propyl, butyl, or CH₂Ph, and
wherein, β and β′ are each independently H, OH, CN, F, NH₃+, CO₂H, CO₂Me, CONH₂, methyl, ethyl, propyl, butyl, phenyl,

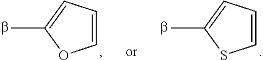

4. The organic redox flow battery of claim 3, wherein α is methyl.

5. The organic redox flow battery of claim 3, wherein β is H.

6. The organic redox flow battery of claim 3, wherein β′ is methyl.

7. The organic redox flow battery of claim 3, wherein α is methyl, β is H, and β′ is methyl.

8. The organic redox flow battery of claim 1, further comprising a catholyte that is chloride, bromide, iodide, potassium ferrocyanide, ferrocene, 2,2,6,6-tetramethyl-1-piperidinyloxy (TEMPO), a benzoquinone, an anthraquinone, cerous methanesulfonate, or manganese dioxide.

9. The organic redox flow battery of claim 1, further comprising a counterion, wherein the counterion is chloride, bromide, iodide, sulfate, phosphate, acetate, trifluoroacetate, tetrafluoroborate, or hexafluorophosphate.

10. The organic redox flow battery of claim 1, further comprising a supporting electrolyte that is sodium hydroxide, perchloric acid, potassium chloride, sulfuric acid, tetrabutylammonium tetrafluoroborate, tetraethylammonium phosphate, lithium hexafluorophosphate, or trifluoroacetic acid.

11. The organic redox flow battery of claim 1, wherein the anolyte has a redox potential of about −1.5 V to about +1.5 V versus a standard hydrogen electrode.

12. The organic redox flow battery of claim 1, further comprising a membrane wherein the membrane is a proton exchange membrane, a cation exchange membrane, an anion exchange membrane, a porous membrane, or a bipolar membrane.

13. An organic redox flow battery having an anolyte that is a pyrazolium.

14. The organic redox flow battery of claim 13, wherein the pyrazolium has the structure: 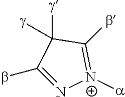
wherein α is methyl, ethyl, propyl, butyl, or CH₂Ph,
wherein β and β′ are each independently H, CO₂H, CO₂Me, CONH₂, methyl, ethyl, propyl, butyl, phenyl, 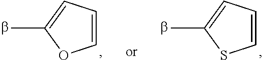
and
wherein γ and γ′ are each independently H, CO₂H, CO₂Me, CONH₂, methyl, ethyl, propyl, butyl, phenyl,

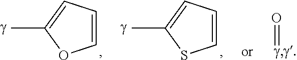

15. The organic redox flow battery of claim 13, wherein at least one α, β, β′, γ, or γ′ is methyl.

16. The organic redox flow battery of claim 13, wherein all of α, β, β′, γ, and γ′ are methyl.

17. An organic redox flow battery having an anolyte that is a 1,2-benzisothiazole.

18. The organic redox flow battery of claim 17, wherein the 1,2-benzisothiazole has the structure: 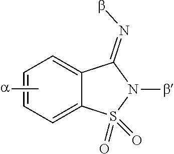
wherein α is H, OH, NH₂, Cl, F, SO₃H, PO₃H₂, CO₂H, CO₂Me, CONH₂, methyl, ethyl, propyl, butyl, phenyl, 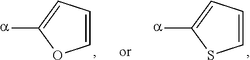
wherein β is H, methyl, ethyl, propyl, butyl, phenyl, or CH₂Ph, and
wherein β′ is absent, H, methyl, ethyl, propyl, butyl, phenyl, or β-CH₂Ph.

19. The organic redox flow battery of claim 17, wherein α is H, β is methyl, or β′ is absent.

20. The organic redox flow battery of claim 17, wherein α is H, β is methyl, and β′ is absent.
